(19) United States
(12) Patent Application Publication
(10) Pub. No.: US 2009/0244102 A1
(43) Pub. Date: Oct. 1, 2009

(54) LCD, LIQUID CRYSTAL DISPLAY DEVICE, AND THEIR DRIVE METHOD

(76) Inventors: Kiyoshi Nakagawa, Yokohama-shi Kanagawa (JP); Toshihiro Yanagi, Nara-shi, Nara (JP); Asahi Yamato, Itabashi-ku, Tokyo (JP); Yuki Kawashima, Yokohama-shi, Kanagawa (JP); Kozo Takahashi, Minatu, Tokyo (JP)

Correspondence Address: HARNESS, DICKEY & PIERCE, P.L.C., P.O. BOX 8910, RESTON, VA, 20195, US

(21) Appl. No.: 11/990,858

(22) PCT Filed: Aug. 29, 2006
(86) PCT No.: PCT/JP2006/317009

§ 371 Date: Feb. 22, 2008

(30) Foreign Application Priority Data
Aug. 31, 2005 (JP) 2005-252735

(51) Int. Cl. G06F 3/038; G09G 5/10; G09G 3/36

(52) U.S. Cl. 345/690; 345/213; 345/89

(57) ABSTRACT

In one embodiment of the present invention, the liquid crystal display device of the invention performs an overshoot drive, including: an LCD having a liquid crystal panel for displaying video image; a frame memory installed outside of the LCD; and lookup table, the table with which third gray scale data most suitable for performing the overshoot drive to the LCD can be computed based on first gray scale data of a first frame and second gray scale data of a second frame, where the second frame is a frame right before the first frame and is stored in the frame memory in advance, wherein lookup table data is stored for each response speed characteristic of the LCD. Thus, without rewriting of lookup table data, the liquid crystal display device having the lookup table most suitable for performing the overshoot drive is realized while high display quality is maintained therein.

### TECHNICAL FIELD

The present invention relates to a liquid crystal display device that performs an overshoot drive with use of a lookup table and to a drive method for the liquid crystal display device.

### BACKGROUND ART

Recently, development of Flat Panel Displays (FPDs) has been remarkable, and various types of the FPDs replace Cathode-ray tube monitors (CRTs). Particularly, technology of liquid crystal display devices (LCDs), which are pioneers to the FPDs, has progressed remarkably. They are now used in various aspects of a daily life and are expected further to be developed.

However, the LCDs still involve some fatal problems. One of them is that the LCDs have weaknesses in video image display. One of the main reasons for this is that a response speed of liquid crystal is slow. The response speed of the liquid crystal is often considered as a switching speed between white and black. As a result of the replacement of the Cathode-ray monitors as described above, a switching between intermediate gray scales attains large proportions; therefore, the response speed between the intermediate gray scales has to be considered. In addition, generally, the response speed is slower in the switching between intermediate gray scales than in the switching between white and black. Therefore, the slow response speed between intermediate gray scales is a problem.

Thus, speeding up the response speed is an inevitable issue in replacing televisions from the CRTs to LCDs, and how to speed up the response speed of the liquid crystal between any gray scales becomes a main task. An overshoot drive is proposed as one of resolution methods to the above task. FIG. 10 illustrates an example of the method for performing the overshoot drive. When the liquid crystal switches from a gray scale level (gray scale) A of one frame to a gray scale level B of a next frame, the liquid crystal generally switches more quickly as a difference between the gray scale level A and the gray scale level B becomes bigger.

Consequently, in a case of a rise response of A<B as illustrated in FIG. 10, an overshoot gray scale C of a gray scale level of B<C is inputted and immediately after that, the target gray scale level B is inputted. As a result, the liquid crystal can switch more quickly than in an ordinary case in which the liquid crystal switches from A to B. On the other hand, in a case of a decay response of A>B, the overshoot gray scale C of a gray scale level of B>C is inputted before the targeted gray scale level B is inputted such that the liquid crystal can switch more quickly than in an ordinal case in which the liquid crystal switches from A to B.

Practically, the liquid crystal switches most quickly at a time of a full gray scale switching (for example, a switching from 0 gray scale to 255 gray scale); therefore, theoretically, the response speed by the overshoot drive can be speeded up, between any gray scales, to the response speed of the full gray scale switching. Thus, in a liquid crystal display mode where the switching between the full gray scales responses quickly enough, the use of the overshoot drive makes it possible to realize the LCD in which sufficiently high-speed response can be gained for the switching between any gray scales.

For the performance of the overshoot drive, how the gray scale C is determined is an important factor.

An LUT-ROM (Lookup Table-Read Only Memory) having a lookup table is used for the determination of the gray scale C. That is, the gray scale C is determined by comparing the gray scale A of the one frame to the gray scale B of the next frame with reference to the lookup table.

As FIG. 11 illustrates, a conventional liquid crystal display device performing the overshoot drive has an external signal source 54 including: an input signal section 50; an LUT-ROM 51; a Logic Controller (a Controller) 52; and a frame memory 53 and an LCD 55. The LUT-ROM 51 contains a lookup table inside of it, which is not illustrated. As a matter of convenience of explanation, a “respond speed” characteristic of the LCD 55 is referenced by a characteristic C.

The operation of this liquid crystal display device will be explained below.

For example, a video image signal composed of 8-bit digital data (gray scale value) is sequentially inputted by the input signal section 50 to the frame memory 53 and stored for a one-frame period, and then outputted to the controller 52. The controller 52 controls the operation of the frame memory 53.

The controller 52 supplies the output of the frame memory 53 to the LUT-ROM 51 as an input 1. On the other hand, the input from the input signal section 50 to the controller 52 is directly supplied to the LUT-ROM 51 as an input 2.

By this, the LUT-ROM 51 generates an output for performing the overshoot drive based on gray scale values of the input 1 and the input 2, and provides it to the LCD 55 through the controller 52.

Patent Document 1 (Japanese Unexamined Patent Application Publication, Tokukai, No. 2004-78129 (published on Mar. 11, 2004) discloses a configuration where most significant 4 bits of an 8-bit input data and most significant 4 bits of an 8-bit former frame data are inputted into the lookup table, and least significant 4 bits of the input data are added to an output of the lookup table. According to this configuration, it is possible that differences among output data are decreased as much as possible while an amount of memory of the lookup table is reduced.

### DISCLOSURE OF INVENTION

However, a following problem arises in the conventional liquid crystal display device and the drive method therefor.

A response speed characteristic of the LCD varies widely for each manufacturing line and lot. Here, the “response speed” refers to a time period during which brightness of a gray scale of an n^{th} frame actually reaches to brightness of a gray scale of an n+1^{th} frame as the gray scale of the n^{th} frame is changed to the gray scale of the n+1^{th} frame in video image.

As FIG. 12 illustrates, when an LCD 56 having a different response speed characteristic D is used, a most suitable value for a coefficient of the overshoot drive differs from that of the LCD 55 having the response speed characteristic C. Thus, if the LUT-ROM 51 most suitable for performing the overshoot to the LCD 55 having the response speed characteristic C is directly used to the LCD 56 having the response speed characteristic D, the LCD 56 will have either of following problems. (i) Display quality of video image on the LCD 56 decreases or (ii) the response speed of the LCD 56 becomes slower, compared to a case in which an LUT-ROM most suitable for performing the overshoot drive to the LCD 56 is used.

To solve the problem above, it is necessary to rewrite a lookup table data of the LUT-ROM 51 so that the LUT-ROM 51 most suitable for performing the overshoot drive to the LCD 55 is changed to the LUT-ROM most suitable for performing the overshoot drive to the LCD 56.

In other words, since the most suitable value for the coefficient of the overshoot drive may vary, the overshoot drive cannot be performed most suitably with a primary LUT-ROM data; therefore, the lookup table data of the LUT-ROM requires to be rewritten each time in accordance with the response speed characteristics of the LCD.

The present invention is accomplished in view of the aforementioned problem. An object of the present invention is to provide, without rewriting of the lookup table data, a liquid crystal display device having the lookup table most suitable for performing the overshoot drive and a drive method for the liquid crystal display device while high display quality is still maintained. Further, an object of the present invention includes providing the above LCD and a drive method for the same.

The LCD of the present invention is an LCD that performs the overshoot drive so as to solve the above task, having a liquid crystal panel for displaying a video image wherein the lookup table data with which the third gray scale data most suitable for performing the overshoot drive to the LCD can be computed based on the first gray scale data of the first frame and the second gray scale data of the second frame, the frame one frame prior to the first frame, is stored for each response speed characteristic of the LCD.

According to the present invention, the method for operating the LCD is a method for operating the LCD that performs the overshoot drive, having a liquid crystal panel for displaying the video image wherein the lookup table data with which the third gray scale data most suitable for performs the overshoot drive to the LCD can be computed based on the first data of the first frame and the second data of the second frame, the frame one frame prior to the first frame, is stored for the each response speed characteristic of the LCD.

The liquid crystal display device of the present invention, in order to solve the above task, is a liquid crystal display device that performs the overshoot drive, having: the LCD including the liquid crystal panel for displaying video image; the frame memory installed outside of the LCD; and the lookup table, the table with which the third gray scale data most suitable for performing the overshoot drive to the LCD can be computed based on the first gray scale data of the first frame and the second gray scale data of the second frame, the frame one frame prior to the first frame, preliminarily stored in the frame memory wherein the lookup table data is stored for the each response speed characteristic of the LCD.

Further, in order to solve the above task, according to the present invention, the method for operating the liquid crystal display device is a method for operating a liquid crystal display device that performs the overshoot drive, having: the LCD including the liquid crystal display panel for displaying video image; the frame memory installed outside of the LCD; the lookup table; and the lookup table, the table with which the third gray scale data most suitable for performing the overshoot drive can be computed based on the first gray scale data of the first frame and the second gray scale data of the second frame, the frame one frame prior to the first frame, preliminarily stored in the frame memory wherein the lookup table data is stored for the each response speed characteristic of the LCD.

Here, the response speed refers to a time period which is required to actually change the brightness of the gray scale of the n^{th} frame to the brightness of the gray scale of the n+1^{th} frame as the gray scale of the n^{th} frame is changed to the gray scale of the n+1^{th} frame in video image.

Referring to the preliminarily stored lookup table data, the liquid crystal display device computes the third gray scale data most suitable for performing the overshoot drive, in other words, the overshoot gray scale data inputted for a second when it is used for the overshoot drive, based on the first gray scale data of the first frame first frame (present gray scale data) and the second gray scale data of the second frame (former gray scale data), which is one frame after the first frame.

The response speed described above, in other words, the response speed characteristic, differs (varies widely) for each manufacturing line and lot. Therefore, the coefficient of the overshoot drive most suitable for performing the overshoot drive differs from one LCD to another. Thus, if same lookup tables are used for operating LCDs having different coefficients of the overshoot drive, either problem that display quality of video images on the LCDs decrease or that the response speeds of the LCDs become slower, compared to the case in which LUT-ROMs most suitable for performing the overshoot drive to the LCDs are used will arise.

In response to such problem, according to the configuration above, the lookup table data is preliminarily stored for each response speed characteristic of the LCD. As a result, without rewriting of the contents of the lookup table data for each time, the response speed of the LCD can always be stably at a same speed as in a case that the most suitable lookup table is used, while the display quality of the video image on the LCD is maintained.

For a fuller understanding of the nature and advantages of the invention, reference should be made to the ensuing detailed description taken in conjunction with the accompanying drawings.

### BRIEF DESCRIPTION OF DRAWINGS

FIG. 1 is a view illustrating an embodiment of the present invention, schematically illustrating a configuration of a liquid crystal display device.

FIG. 2 is a view schematically illustrating an input and output of gray scale data in an external signal source 2 and an LUT-ROM 6.

FIG. 3 is a graph showing a relation between brightness and time in an LCD.

FIG. 4(a) is a view schematically illustrating a configuration of a liquid crystal display device equipped with an LCD having a response speed characteristic A.

FIG. 4(b) is a view schematically illustrating a configuration of a liquid crystal display device equipped with an LCD having a response speed characteristic B (different from the characteristic A).

FIG. 5 is a graph showing response speeds in cases in which brightness (gray scales) of gray scales of n^{th} frames are changed to gray scales of n+1^{th} frames without performances of the overshoot drive in the LCD 1 having the characteristic A and in the LCD 1′ having the characteristic B respectively.

FIG. 6 is a graph showing a result when the overshoot drive is performed to the LCD having the characteristic A with use of an LUT-ROM.

FIG. 7 is a graph showing a result when the overshoot drive is performed to the LCD 1′ having the characteristic B with use of an LUT-ROM 6 having a lookup table into which the same data as used in FIG. 6 is written

FIG. 8(a) is a view schematically illustrating an exemplary configuration of an LCD of the present embodiment while FIG. 8(b) is a view schematically illustrating a data area of EEPROM illustrated in FIG. 8(a).

FIG. 9(a) is a view schematically illustrating a configuration of an LCD of the present embodiment while FIG. 9(b) is a view schematically illustrating a data area of EEPROM illustrated in FIG. 9(a).

FIG. 10 is a waveform chart showing an exemplary signal for operating a switching by one-field overshoot drive.

FIG. 11 is a view schematically illustrating a configuration of a conventional liquid crystal display device.

FIG. 12 is a view schematically illustrating a configuration of a conventional liquid crystal display device.

### BEST MODE FOR CARRYING OUT THE INVENTION

### Embodiment 1

One embodiment of the present invention is described below with reference to drawings.

FIG. 1 is a view schematically illustrating a configuration of the liquid crystal display device of the present embodiment.

This liquid crystal display device performs the so-called overshoot drive. Here, “the overshoot drive” is a driving method for impressing an excessive signal voltage to a liquid crystal cell in a short period of time, and with this overshoot drive, a change in molecular orientation of the liquid crystal substance is speeded up such that display quality of the video image can be improved.

As FIG. 1 illustrates, the liquid crystal display device of the present embodiment has an LCD (Liquid Crystal Display; LCD module) 1 and an external signal source 2.

The LCD 1 has an active matrix type liquid crystal panel (panel) 3 equipped with a thin film transistor (TFT) as a switching element, drivers (a source driver, a gate driver; not illustrated) for operating the liquid crystal panel, an EPC 4, and a connector 5.

What should be noted here is that the EPC (Flexible Printed Circuit) 4 (LCD 1 in other words) is provided with an LUT-ROM (Lookup Table-Read Only Memory) 6, which is a memory equipped with a lookup table (LUT). A most important part of the present invention is that the LCD 1 is provided with the LUT-ROM 6 as described above, in other words, that the LCD 1 is provided with the lookup table. This will be described later. Here, the look up table data is stored in the ROM, yet it may be stored in a RAM instead of the ROM.

The liquid crystal panel 3 has a plurality of source bus lines (not illustrated) aligned parallel to each other in a lengthwise direction of a screen and a plurality of scanning lines (not illustrated) aligned parallel to each other in a crosswise direction of the screen. Outside of the liquid crystal panel 3, the source bus lines are connected to the source driver while the scanning lines are connected to the gate driver. Besides, the source bus lines are orthogonal to the scanning lines, and pixels (not illustrated) are provided at intersections. To these pixels, the TFTs (Thin Film Transistor; not illustrated) and liquid crystal cells (not illustrated) are disposed.

An operation of the liquid crystal panel 3 will be briefly explained below. In order to display video image on the liquid crystal display 3, the gate driver sequentially turns on the TFTs connected to the each scanning line while the source driver applies, into the pixels associated with the each scanning line, the gray scale voltage responding to gray scale data (video image data) associated with the each scanning line. The EPC 4 is provided such that various types of circuits can be bent.

The external signal source 2 is provided outside of the LCD 1 and includes a Logic controller (controller) 7, a frame memory 8, and an input signal section 9.

The controller 7 takes a role to control the operations of the source driver and the gate driver. Besides, the controller 7 transmits the gray scale data (the video image data), which are digital data, to the source driver. According to this gray scale data, the gray scale voltage to be applied into the each pixel through the source driver is determined. In addition, the controller 7 transmits to the gate driver a signal indicating scanning timing. Moreover, the controller 7 transmits to the source driver a signal directing the source driver to switch and output the gray scale voltage synchronously with the scanning timing.

The gray scale data to be transmitted by the controller 7 to the source driver is outputted from the LUT-ROM 6 to the controller 7.

The frame memory 8 is a FIFO (First-in First-out) style memory, which is able to store gray scale data of a one-frame period. Thus, the frame memory 8 can process the data input and data output at the same time. Also, the use of the frame memory 8 makes it possible to output the gray scale data (second gray scale data) delayed for the one-frame period with a simple configuration. The gray scale data delayed for the one-frame period is outputted to the LUT-ROM 6 through the controller 7.

Next, the operation of the overshoot drive of the liquid crystal display device illustrated in FIG. 1 will be explained in detail.

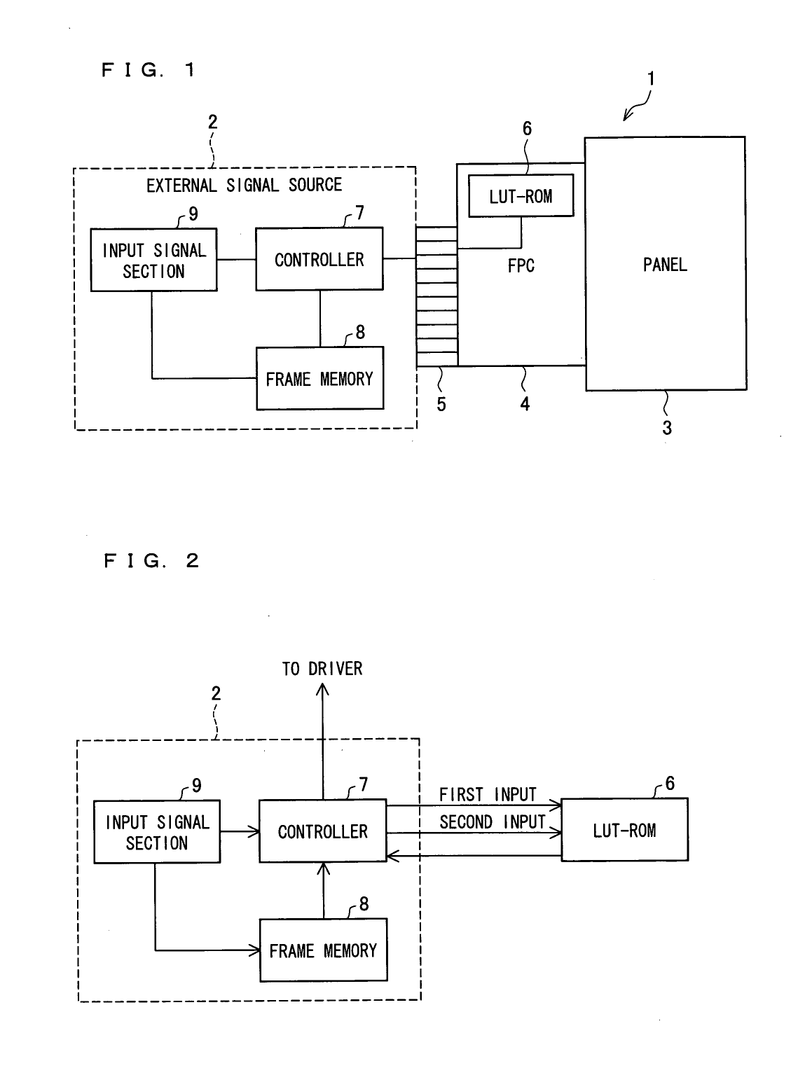

FIG. 2 is a view schematically illustrating how the gray scale data is inputted and outputted to/from the external signal source 2 and the LUT-ROM 6. In FIG. 1 and FIG. 2, the configuration includes the single LUT-ROM 6 and the single frame memory 8, yet if the liquid crystal panel 3 can display colors of “RGB” and if the gray scale data is color data of “RGB,” the configuration may include the LUT-ROMs 6 and the frame memories 8 independently for each gray scale data of “RGB.”

The LUT-ROM 6 has two inputs. To one of the two inputs (a first input), the gray scale data transmitted from the input signal section 9 is inputted through the controller 7, and to the other input (a second input), the gray scale data stored once in the memory 8 after being transmitted from the input signal section 9 is inputted through the controller 7. The gray scale data inputted to the second input is delayed for the one-frame period compared with the gray scale data.

As described above, the gray scale data of the frame to be displayed (the first frame), which is outputted from the input signal section 9, (present gray scale data; the first gray scale data) is simultaneously inputted to the frame memory 8 and to the first input of the LUT-ROM 6 through the controller 7. Further, the gray scale data of a frame, the frame one frame prior to the frame to be displayed (immediately preceding frame; the second frame), (former gray scale data; the second gray scale data) is outputted from the frame memory 8 and inputted to the second input of the LUT-ROM 6.

Then, based on the present gray scale data and the former gray scale data, the LUT-ROM 6 outputs certain gray scale data (third gray scale data) from the preliminarily set lookup table to the controller 7. With the third gray scale data, the overshoot drive is performed.

In the above, it is explained that the present gray scale data and the former gray scale data as such are inputted to the LUT-ROM 6 from the controller 7. However, for example, a difference between the present gray scale data and the former gray scale data may be inputted to the LUT-ROM 6, the difference being calculated by the controller 7. This can decrease memory size of the LUT-ROM 6.

Further, the configuration of the LUT-ROM 6 (the configuration of the lookup table) can be considered in forms of an 8×8 gray scale, a 16×16 gray scale, a 32×32 gray scale, a 64×64 gray scale, a 128×128 gray scale, a 256×256 gray scale, and the like. It may be preferable to read out data of the LUT-ROM 6 (for example, data of the 8×8 gray scale); then to convert it into data of the 256×256 gray scale by complementing grids at the controller 7; and to output two signals (the present gray scale data and the former gray scale data) to the LUT-ROM 6. Also, it is preferable that the lookup tables be respectively prepared for certain temperatures.

In addition, the controller 7 above counts vertical synchronizing signals when it turns on the LCD 1, and reads out signals from the LCD immediately after the counts reach to certain number of times. The controller 7 thereafter controls the LUT-ROM 6 until power is applied once again.

Next, a working effect deriving from the configuration where the LUT-ROM 6 is provided to the LCD 1, which is the most important part of the present invention, will be explained.

As described above, the LUT-ROM is conventionally provided to the external signal source. Thus, such problem as below has arisen. The most suitable value for the coefficient of the overshoot drive would vary among LCDs due to variances among manufacturing lines and lots. More specifically, the response speed characteristic of the LCD differs from one LCD to another. Therefore, the lookup table data of the LUT-ROM requires to be rewritten according to the response speed characteristic of the LCD each time the overshoot drive is performed.

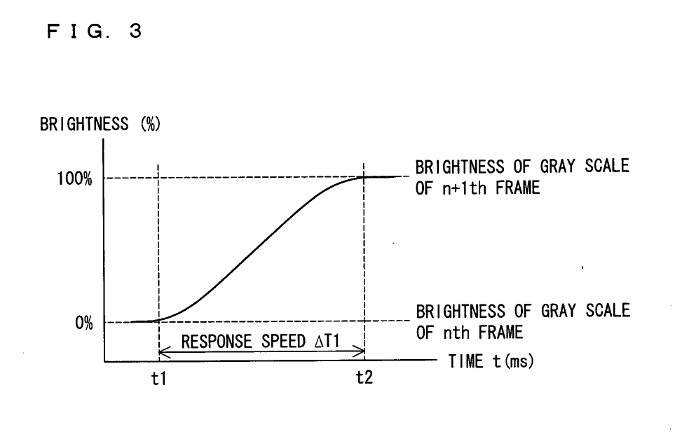

As FIG. 3 illustrates, “the response speed” here refers to a time period (ΔT1=t2−t1) which is required to actually change brightness of a gray scale of an n^{th} frame (0%) to brightness of a gray scale of an n+1^{th} frame (100%) as the gray scale of the n^{th} frame is changed to the gray scale of the n+1^{th} frame in video image, where t1 is time at which brightness of the gray scale of the n^{th} frame is gained and t2 is time at which brightness of the gray scale of the n+1^{th} frame is gained. Also, in FIG. 3, a longitudinal coordinate represents brightness (%) while a horizontal coordinate represents time (ms). The response speed may also refer to as a time period which is required to change brightness from 10% to 90% when it is put that a difference in brightness between the n^{th} frame and the n+1^{th} frame is 100%.

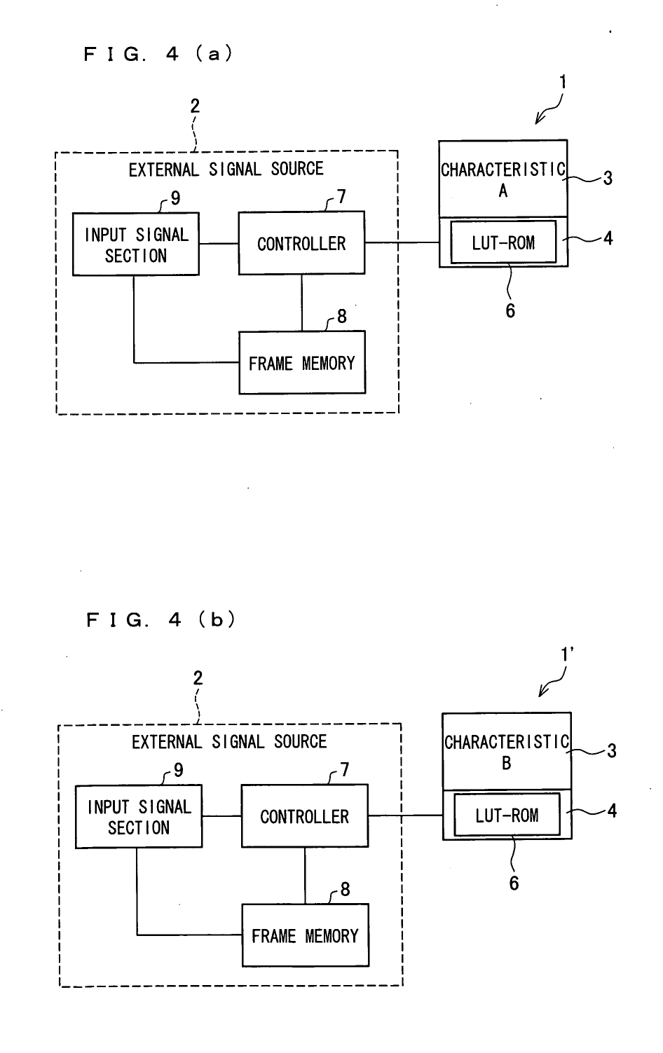

FIG. 4(a) is a view schematically illustrating a configuration of a liquid crystal display device equipped with the LCD having a response speed characteristic A. FIG. 4(b) is a view schematically illustrating a configuration of a liquid crystal display device equipped with an LCD having the response speed characteristic B (different from the characteristic A).

These liquid crystal display devices are equipped with LUT-ROMs 6 having lookup tables into which identical data are written down and are configured in such manner that they can perform the overshoot drive. Into the lookup tables of the LUT-ROMs 6, data most suitable for performing the overshoot drive to the LCD 1 having the characteristic A are written down. In FIG. 4(a) and FIG. 4(b), the connectors 5 illustrated in FIG. 1 are not illustrated.

FIG. 5 is a graph showing response speeds in a case in which brightness (gray scale) of a gray scale of an n^{th} frame is changed to a gray scale of an n+1^{th} frame without a performance of the overshoot drive in the LCD 1 having the characteristic A and in the LCD 1′ having the characteristic B respectively.

As illustrated in FIG. 5, the response speed of the LCD 1 having the characteristic A is ΔT2 (t4−t3) while the response speed of the LCD 1′ having the characteristic B is ΔT3 (t5−t3; ΔT3>ΔT2). That is, the response speed of the LCD 1′ having the characteristic B is faster than that of the LCD 1 having the characteristic A. In FIG. 5, time at which the gray scales of the n^{th} frame are gained in the LCD 1 having the characteristic A and the LCD 1′ having the characteristic B is t3: time at which the gay scale of the n+1^{th} frame is gained in the LCD 1′ having the characteristic B is t4; and time at which the gray scale of the n+1^{th} frame is gained in the LCD 1 having the characteristic A is t5.

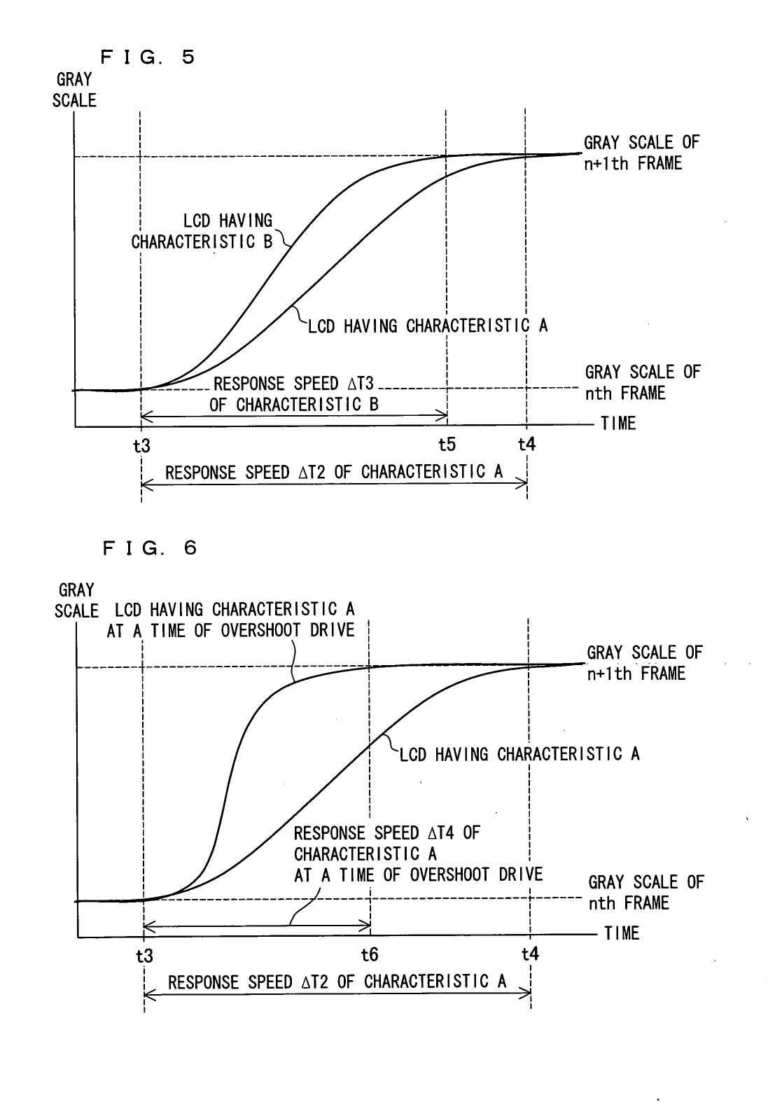

FIG. 6 is a graph showing a relation between a gray scale and time as a result of a performance of the overshoot drive to the LCD having the characteristic A with use of the lookup table data of the LUT-ROM 6.

As FIG. 6 illustrates, in a case that the overshoot drive is performed, time at which the gray scale of the n+1^{th} frame is gained is t6 (<t4) and the response speed is Δ4 (t6−t3; <ΔT2); therefore, the response speed becomes faster, compared to the case illustrated in FIG. 5 where the overshoot drive is not performed.

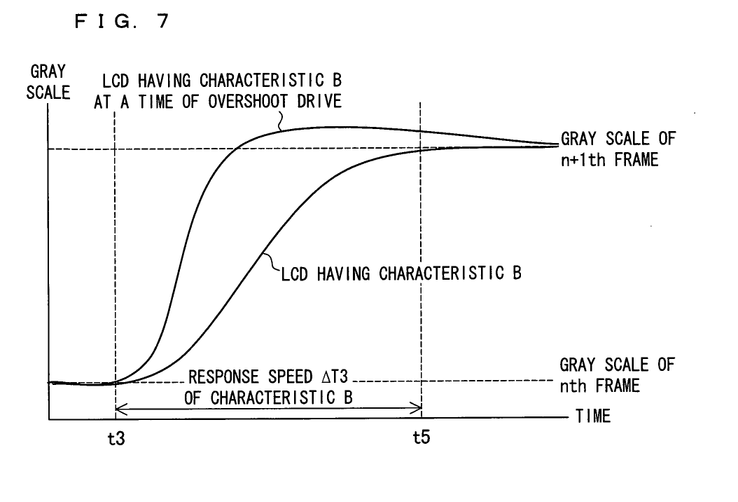

FIG. 7 is a graph showing a relation between a gray scale and time as result of the performance of the overshoot drive to the LCD 1′ having the characteristic B with use of the LUT-ROM 6 having the lookup table into which the same data as used in FIG. 6 are written down.

In this case, as FIG. 7 illustrates, a gray scale−time curve outreaches the gray scale of the n+1^{th} frame. Thus, the display quality decreases. This is because an LUT-ROM 6 identical with the LUT-ROM 6 most suitable for performing the overshoot drive to the LCD 1 having the characteristic A is used to the LCD 1′ having the characteristic B even though their characteristics are different.

On the other hand, though it is not illustrated in a figure, if the overshoot drive is performed to the LCD 1 having the characteristic A with use of the LUT-ROM (not illustrated) most suitable for performing the overshoot drive to the LCD 1′ having the characteristic B, the response speed becomes slower, compared to a case where the overshoot drive is performed with the use of the LUT-ROM 6 most suitable for performing the overshoot drive to the LCD 1 having the characteristic A. The response speeds of the LCD 1 having characteristic A can be described in the following order: when the LUT-ROM 6 most suitable for performing the overshoot drive to the LCD 1 having the characteristic A is used to the LCD 1>when the LUT-ROM most suitable for performing the overshoot drive to the LCD 1′ having the characteristic B is used to the LCD 1 having the characteristic A>when the overshoot drive is not performed to the LCD 1 having the characteristic A.

Therefore, conventionally, the LUT-ROM data is rewritten each time in accordance with a speed characteristic of an LCD.

On the other hand, the LUT-ROM 6 is provided to the LCD 1 in the present embodiment as described above, and the LUT-ROM 6 suitable for the response speed characteristic of the LCD 1 (that is, most suitable for performing the overshoot drive) is provided.

Consequently, regardless of the variances of the response speed characteristics in the LCD lines or lots, an effect that response speed can be speeded up without decreases in the display quality can be gained without rewriting of the lookup table data of the LUT-ROM from an outside source.

In the explanation above, the gray scale data from the input signal section 9 is directly inputted to the frame memory 8; however, the present invention is not limited to the configuration, and the gray scale data may be inputted to the frame memory 8 through the controller 7. Further, the LUT-ROM is not necessarily provided to the LCD. It may be provided for each response speed characteristic of the LCD.

### Embodiment 2

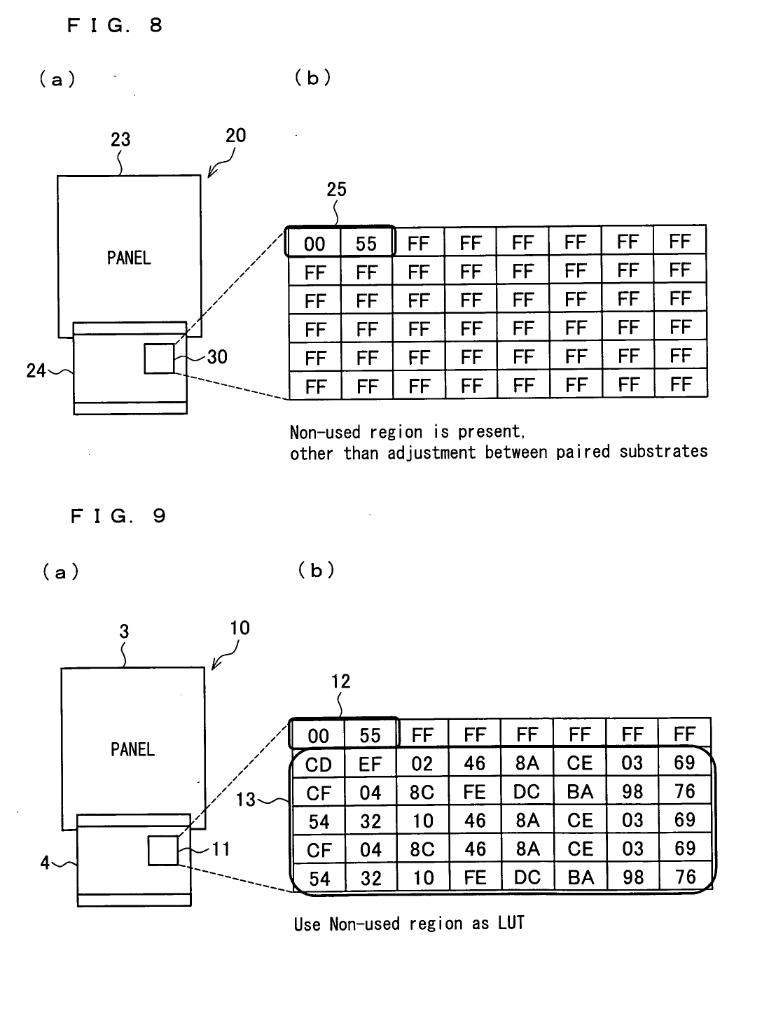

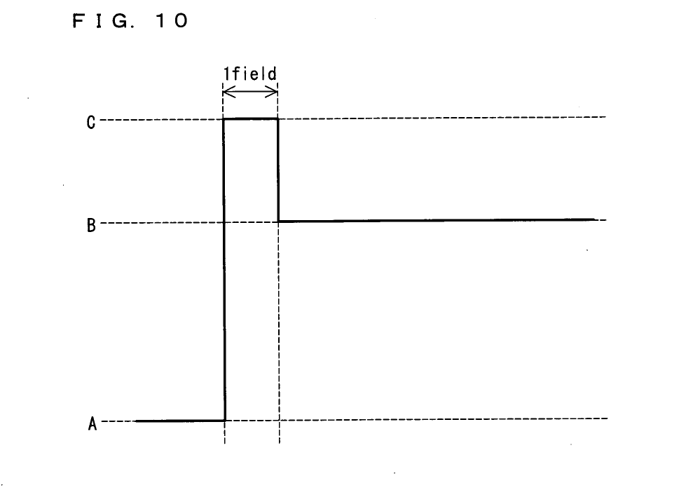

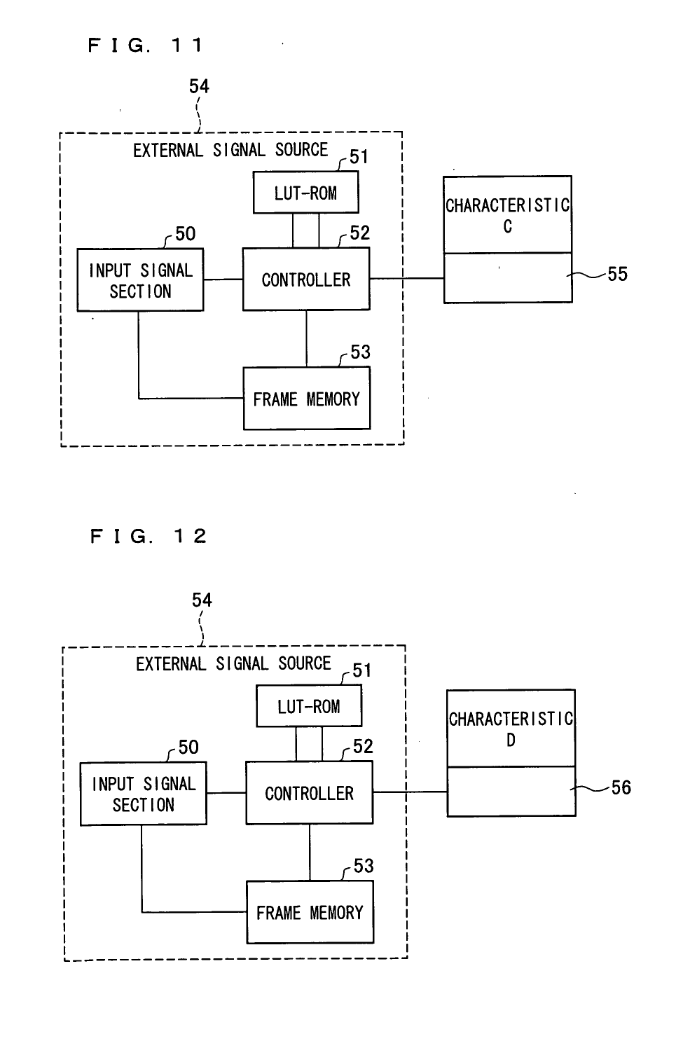

Another embodiment of the present invention is described below with reference to FIG. 8 and FIG. 9. In the present embodiment, differences with the embodiment 1 are described; therefore, as a matter of convenience, members having the same functions as those described in the embodiment 1 are referenced by the same reference numerals in the preset embodiment and are not described further.

FIG. 8(a) is a view schematically illustrating an exemplary configuration of an LCD while FIG. 8B is a view schematically illustrating a data area of an EEPROM (electrically erasable/programmable read only memory) illustrated in FIG. 8(a). Recently, cases that the EEPROMs are installed for adjustment between paired electrodes in a module.

As FIG. 8(a) illustrates, an exemplary LCD 20 includes a liquid crystal panel 23, an FPC 24, and EEPROM 30.

The EEPROM 30 is, as FIG. 8(a) illustrates, provided to the EPC 24 in the LCD 20. Also, as FIG. 8(b) illustrates, there is a non-used region in the EEPROM 30 apart from an adjustment area 25 for potential adjustment between paired electrodes. In the potential adjustment area 25, adjustment values (“00” and “55” here) are stored.

FIG. 9(a) is a view schematically illustrating a configuration of an LCD of the present embodiment while FIG. 9B is a view schematically illustrating a data area of the EEPROM illustrated in FIG. 9(a).

An LCD 10 of the present embodiment includes a liquid crystal panel 3, an FPC 4, and an EEPROM 11 as the exemplary LCD 20 does.

As FIG. 9(b) illustrates, a part of the non-used region 13 besides an adjustment area 12 for adjustment between paired electrodes is used as the lookup table in the EEPROM 11 of the present embodiment.

By this, the same effect as attained with the embodiment 1 can be attained with a conventional module, that is, the most suitable overshoot drive can be performed without changing the module.

Further, in the liquid crystal display device and the LCD of the present invention, the lookup table is preferably provided to the LCD.

According to the above configuration, the lookup table is installed to the LCD. Thus, the table can be installed for each line and lot at the time of manufacture, and manufacturing efficiency can be enhanced. That is, the lookup tables most suitable for performing the overshoot drive to the LCD can be installed to the LCDs for each manufacturing line and lot.

In addition, the liquid crystal display device of the present invention is preferably arranged such that the LCD includes a flexible printed substrate, to which the lookup table is provided.

According to the above configuration, the lookup table is provided to the flexible printed substrate. Thus, the lookup table can be easily provided. Besides, an open space of the flexible printed substrate can be efficiently used, and downsizing can be achieved.

Furthermore, the liquid crystal display device of the present invention is preferably arranged such that the lookup table is preferably incorporated in the ROM.

In addition, the liquid crystal display device of the present invention is configured such that the ROM is the EEPROM used for potential adjustment between paired electrodes in the LCD.

Recently, the EEPROM has been frequently used for potential adjustment between paired electrodes in the LCD. Thus, if this EEPROM for potential adjustment between paired electrodes in the LCD is used, a labor to change design of the LCD or to install a new memory can be overleapt.

Besides, the liquid crystal display device is preferably configured such that the non-used region of the data area in the EEPROM is used for the lookup table, the non-used region being a region not allocated for the potential adjustment.

The LCD of the present invention is an LCD that performs an overshoot drive, comprising a liquid crystal panel for displaying the video image wherein the lookup table data with which the third gray scale data most suitable for performing the overshoot drive to the LCD is able to be computed based on the first gray scale data of the first frame and the second gray scale data of the second gray scale frame, is stored for each response speed characteristic of the LCD, where the second frame is a frame right before the first frame.

According to the present invention, the drive method is a drive method for an LCD that performs the overshoot drive, the LCD comprising a liquid crystal display panel for displaying video image, the method including storing, for each response speed characteristic of the LCD, the lookup table data with which the third data most suitable for performing the overshoot drive to the LCD is able to be computed based on the first gray scale data of the first frame and the second gray scale data of the second frame, where the second frame is a frame right before the first frame.

The liquid crystal display device of the present invention is a liquid crystal display device that performs the overshoot drive, including: the LCD including the liquid crystal panel for displaying video image; the lookup table, the frame memory provided outside of the LCD, wherein: the third gray scale data most suitable for performing the overshoot drive to the LCD is computed based on the first gray scale data of the first frame and the second gray scale data of the second frame by using the lookup table, where the second frame is a frame right before the first frame and is stored in the frame memory in advance; and lookup table data on the lookup table is stored for each response speed characteristic of the LCD.

According to the present invention, the drive method is a drive method for the liquid crystal display device that performs the overshoot drive, including: the LCD including the liquid crystal panel for displaying video image; the lookup table; the frame memory provided outside of the LCD: and the look up table, wherein: the third gray scale data most suitable for performing the overshoot drive to the LCD is computed based on the first gray scale data of the first frame and the second gray scale data of the second gray scale frame by using the lookup table, where the second frame is a frame right before the first frame and is stored in the frame memory in advance; and the lookup table data on the lookup table is stored for each response speed characteristic of the LCD.

Consequently, without rewriting of the lookup table data, the liquid crystal display device having the lookup table most suitable for performing the overshoot drive and the method for operating the same as well as the LCD and the method for operating the same can be provided while the high display quality is maintained.

The invention being thus described, it will be obvious that the same way may be varied in many ways. Such variations are not to be regarded as a departure from the spirit and scope of the invention, and all such modifications as would be obvious to one skilled in the art are intended to be included within the scope of the following claims.

### INDUSTRIAL APPLICABILITY

According to the present invention, the response speed of the liquid crystal can be stably within a requested specification, and a circuit dimension can be downsized. Thus, the present invention is suitable for an instrumental panel for an automobile use where the response speed of the liquid crystal is highly required to be stably at lower temperature.

1. An LCD that performs an overshoot drive, comprising a liquid crystal panel for displaying an image wherein:
lookup table data with which a third gray scale data most suitable for performing the overshoot drive to the LCD is able to be computed based on a first gray scale data of a first frame and a second gray scale data of a second gray scale frame, is stored for each response speed characteristic of the LCD, where the second frame is a frame right before the first frame.

2. The LCD as set forth in claim 1, comprising:
the lookup table.

3. A liquid crystal display device that performs an overshoot drive, comprising: an LCD including a liquid crystal panel for displaying an image; a lookup table, a frame memory provided outside of the LCD, wherein:
a third gray scale data most suitable for performing the overshoot drive to the LCD is computed based on a first gray scale data of a first frame and a second gray scale data of a second gray scale frame by using the lookup table, where the second frame is a frame right before the first frame and is stored in the frame memory in advance; and
a lookup table data on the lookup table is stored for each response speed characteristic of the LCD.

4. The liquid crystal display device as set forth in claim 3 wherein the LCD is comprises the lookup table therein.

5. The liquid crystal display device as set forth in claim 4 wherein the LCD comprises a flexible printed substrate, to which the lookup table is provided.

6. The liquid crystal display device as set forth in claim 3 wherein the lookup table is stored in a ROM.

7. The liquid crystal display device as set forth in claim 6 wherein the ROM is an EEPROM used for potential adjustment between paired electrodes in the LCD.

8. The liquid crystal display device as set forth in claim 7 wherein a non-used region of a data area in the EEPROM is used for the lookup table, the non-used region being a region not allocated for the potential adjustment.

9. A drive method for an LCD that performs an overshoot drive, the LCD comprising a liquid crystal display panel for displaying an image, the method comprising:
storing, for each response speed characteristic of the LCD, a lookup table data with which a third gray scale data most suitable for performing the overshoot drive to the LCD is able to be computed based on a first gray scale data of a first frame and a second gray scale data of a second frame, where the second frame is a frame right before the first frame.

10. A drive method for a liquid crystal display device that performs an overshoot drive, the liquid crystal display device comprising: an LCD including a liquid crystal panel for displaying a video image; a frame memory provided outside of the LCD; a lookup table; and a lookup table, the method comprising:
computing a third gray scale data most suitable for performing the overshoot drive to the LCD, based on a first gray scale data of a first frame and a second gray scale data of a second frame by using the lookup table, where the second frame is a frame right before the first frame and stored in the frame memory in advance; and
storing lookup a table data for each response speed characteristic of the LCD.

11. The liquid crystal display device as set forth in claim 4 wherein the lookup table is stored in a ROM.

12. The liquid crystal display device as set forth in claim 5 wherein the lookup table is stored in a ROM.
